(19) United States
(12) Patent Application Publication
(10) Pub. No.: US 2021/0032151 A1
(43) Pub. Date: Feb. 4, 2021

(54) METHODS OF FABRICATING GLASS SUBSTRATES WITH REDUCED BIREFRINGENCE

(71) Applicant: CORNING INCORPORATED, CORNING, NY (US)

(72) Inventors: Rohit Rai, Painted Post, NY (US); Vitor Marino Schneider, Painted Post, NY (US)

(21) Appl. No.: 17/044,003

(22) PCT Filed: Apr. 4, 2019
(86) PCT No.: PCT/US2019/025904

§ 371 Date: Sep. 30, 2020

Related U.S. Application Data
(60) Provisional application No. 62/747,787, filed on Oct. 19, 2018.
(60) Provisional application No. 62/653,872, filed on Apr. 6, 2018.

(51) Int. Cl. C03B 25/02; C03B 13/02; C03C 21/00

(52) U.S. Cl. CPC C03B 25/025; C03C 21/002; C03B 13/02

(57) ABSTRACT

Methods of processing glass-based substrates to reduce birefringent defects and glass-based substrates are disclosed. In one embodiment, a method for processing a glass-based substrate includes rolling a glass-based material to form the glass-based substrate, and heat treating the glass-based substrate by increasing a temperate of the glass-based substrate, holding the temperature at a maximum temperature for a hold period, and then decreasing the temperature at one or more cooling rates, wherein after the heat treating, the glass-based substrate has a retardance over thickness of 5 nm/mm or less at locations outside of and including 5 mm from any corner of the glass-based substrate and outside of and including 5 mm from any edge of the glass-based substrate.

### CROSS-REFERENCE TO RELATED APPLICATIONS

This application claims the benefit of priority under of 35 U.S.C. § 119 of U.S. Provisional Application Ser. No. 62/747,787, filed on Oct. 19, 2018 and U.S. Provisional Application Ser. No. 62/653,872, filed on Apr. 6, 2018, the contents of each are incorporated by reference in their entirety.

### BACKGROUND

### Field

The present disclosure generally relates to glass-based substrates and methods of processing glass-based substrates, and, more particularly, to methods of reducing birefringence defects in glass-based substrates and glass-based substrates having minimized birefringence defects.

### Technical Background

Glass-based substrates, such as glass substrates or glass ceramic substrates, may be utilized in a wide variety of applications. For example, glass-based substrates may be used as a cover glass in electronic devices, such as smartphones and tablets. These electronic devices are typically backlit by a linearly polarized, quasi-linearly polarized, circularly polarized, or circularly polarized backlight.

The fabrication process of glass-based substrates used in electronic devices may have a non-uniform thermal profile that causes localized residual stress or birefringence that appears within the glass-based substrate. In an example, glass-based substrates may be formed by a rolling process. The rolling process has several advantages regarding the range of viscosities of materials it can make, but the contact nature of forming by use of rollers and conveyors may lead to difficulties in thermal control of the part. This may further lead to birefringence in the resulting glass-based substrate.

Birefringence defects may be visible to a user of an electronic device, particularly in a crossed polarizer situation, such as where a user is wearing polarized sunglasses. One or more defect regions may be visible to the user, such as near an edge of the glass-based substrate.

### SUMMARY

In a first embodiment, a method for processing a glass-based substrate includes rolling a glass-based material to form the glass-based substrate, and heat treating the glass-based substrate by increasing a temperature of the glass-based substrate, holding the temperature at a maximum temperature for a hold period, and then decreasing the temperature at one or more cooling rates, wherein after the heat treating, the glass-based substrate has a retardance over thickness of 5 nm/mm peak-to-valley or less at all locations outside of and including 5 mm from any corner of the glass-based substrate and outside of and including 5 mm from any edge of the glass-based substrate.

In a second embodiment, the method according to the first embodiment, wherein the glass-based substrate is a glass material.

In a third embodiment, the method according to the second embodiment, wherein the glass-based material is an alkali-aluminosilicate glass material.

In a fourth embodiment, the method according to any preceding embodiment, wherein the glass-based substrate does not include lithium.

In a fifth embodiment, the method according to the first or fourth embodiment, wherein the glass-based substrate is a glass-ceramic.

In a sixth embodiment, the method according to any preceding embodiment, wherein prior to the heating treating, the glass-based substrate has a birefringence defect located 1 mm or more from an edge, and the retardance over thickness of the birefringence defect is greater than 5 nm/mm peak-to-valley.

In a seventh embodiment, the method according to the sixth embodiment, wherein the retardance over thickness of the birefringence defect is 8 nm/mm peak-to-valley or more.

In an eighth embodiment, the method of any preceding embodiment, further including thinning the glass-based substrate.

In a ninth embodiment, the method of the eighth embodiment, wherein the thinning occurs before the heat treating.

In a tenth embodiment, the method of the eighth embodiment, wherein the thinning occurs after the heat treating.

In an eleventh embodiment, the method of the eighth embodiment, wherein the thinning includes polishing.

In a twelfth embodiment, the method of any preceding embodiment, wherein the hold period is within a range of five minutes to eight hours, including endpoints.

In a thirteenth embodiment, the method of any preceding embodiment, wherein the glass-based substrate has a thickness within a range of 200 μm and 2 mm, including endpoints.

In a fourteenth embodiment, the method of any preceding embodiment, wherein, after the heat treating, the glass-based substrate has a visual detection of light intensity using a crossed polarizer that varies less than 0.2% compared to a light intensity of light prior to transmission through the glass-based substrate.

In a fifteenth embodiment, the method of any preceding embodiment, wherein a heating rate at which the temperature increases is within a range of 0.1° C./minute to 100° C./minute, including endpoints.

In a sixteenth embodiment, the method of any preceding embodiment, wherein the one or more cooling rates is within a range of 0.1° C./minute to 100° C./minute, including endpoints.

In an seventeenth embodiment, the method of any preceding embodiment, wherein the one or more cooling rates includes a first cooling rate, a second cooling rate, and a third cooling rate.

In an eighteenth embodiment, the method of the seventeenth embodiment, wherein the first cooling rate is 3° C./minute from 620° C. to 560° C., the second cooling rate is 5° C./minute from 560° C. to 510° C., and the third cooling rate is a maximum cooling rate allowed by an oven used for the heat treating.

In a nineteenth embodiment, the method of any preceding embodiment, wherein the maximum temperature is within a range of 450° C. to 1100° C., including endpoints.

In a twentieth embodiment, the method of the nineteenth embodiment, wherein the maximum temperature is within a range of 500° C. to 700° C.

In a twenty-first embodiment, the method of any preceding embodiment, wherein the glass-based substrate has a warp/diagonal of 0.007 μm/mm² or less after the heat treating.

In a twenty-second embodiment, the method of any preceding embodiment, further including strengthening the glass-based substrate by an ion-exchange process after the heat treating.

In a twenty-third embodiment, the method of any preceding embodiment, wherein the retardance over thickness of the glass-based substrate is 3 nm/mm peak-to-valley or less at locations outside of and including 2 mm from any corner of the glass-based substrate and outside of and including 1 mm from any edge of the glass-based substrate.

In a twenty-fourth embodiment, the method of any one of the first through twenty-second embodiments, wherein the retardance over thickness of the glass-based substrate is 3 nm/mm or less within any 25 mm by 25 mm area located outside of and including 2 mm from any corner of the glass-based substrate and outside of and including 1 mm from any edge of the glass-based substrate.

In a twenty-fifth embodiment, a method for processing a strengthened glass substrate, the method includes rolling a glass material to form a glass substrate, wherein the glass substrate has a birefringence defect located 1 mm or more from an edge, and the retardance over thickness of the birefringence defect is greater than 5 nm/mm peak-to-valley. The method further includes heat treating the glass substrate by increasing a temperate of the glass substrate, holding the temperature at a maximum temperature for a hold period, and then decreasing the temperature at a first cooling rate, a second cooling rate, and a third cooling rate. After the heat treating, the glass substrate has a retardance over thickness of 5 nm/mm or less at locations outside of and including 5 mm from any corner of the glass substrate and outside of and including 1 mm from any edge of the glass substrate. The method further includes strengthening the glass substrate by a strengthening. process.

In a twenty-sixth embodiment, the method of the twenty-fifth embodiment, wherein the first cooling rate is 3° C./minute from 620° C. to 560° C., the second cooling rate is 5° C./minute from 560° C. to 510° C., and the third cooling rate is a maximum cooling rate allowed by an oven used for the heat treating.

In a twenty-seventh embodiment, the method of the twenty-fifth or twenty-sixth embodiments, wherein the retardance over thickness of the glass substrate after the heat treating is 3 nm/mm or less at locations outside of and including 2 mm from any corner of the glass substrate and outside of and including 1 mm from any edge of the glass substrate.

In a twenty-eighth embodiment, the method of the twenty-fifth or twenty-sixth embodiments, wherein the retardance over thickness of the glass substrate after the heat treating is 3 nm/mm or less within any 25 mm by 25 mm area located outside of an including 2 mm from any corner of the glass substrate and outside of and including 1 mm from any edge of the glass substrate.

In a twenty-ninth embodiment, the method of any one of the twenty-sixth through twenty-ninth embodiments, wherein the hold period is within a range of five minutes to eight hours, including endpoints.

In a thirtieth embodiment, a method of fabricating one or glass-based articles includes rolling a glass-based material to form a glass-based sheet, heat treating the glass-based sheet by increasing a temperature of the glass-based sheet, and holding the temperature at a maximum temperature for a hold period. The method further includes decreasing the temperature at a cooling rate, wherein after the heat treating, the glass-based sheet has a retardance over thickness of 5 nm/mm peak-to-valley or less at all locations outside of and including 10 mm from any edge of the glass-based sheet. The method further includes removing a first quality area of the glass-based sheet, wherein the first quality area extends at least 10 mm from a first edge of the glass-based sheet and along a length of the glass-based sheet, and the length of the glass-based sheet is a direction of the rolling of the glass-based material, and removing a second quality area of the glass-based sheet, wherein the second quality area extends at least 10 mm from a second edge of the glass-based sheet and along the length of the glass-based sheet. The method also includes separating the one or more glass-based articles from the glass-based sheet.

In a thirty-first embodiment, the method of the thirtieth embodiment, wherein, after heat treating the glass based sheet, the glass-based sheet has a retardance over thickness of 5 nm/mm peak-to-valley or more within at least one of the first quality area and the second quality area.

In a thirty-second embodiment, the method of the thirtieth or thirty-first embodiments, wherein the glass-based material is glass.

In a thirty-third embodiment, the method of the thirty-second embodiment, wherein the glass-based material is an alkali-aluminosilicate glass material.

In a thirty-fourth embodiment, the method of any one of the thirtieth through thirty-third embodiments, wherein the glass-based material does not include lithium.

In a thirty-fifth embodiment, the method of any one of the thirtieth, thirty-first or thirty-fourth embodiments, wherein the glass-based material is a glass-ceramic.

In a thirty-sixth embodiment, the method of any one of the thirtieth through thirty-fifth embodiments, wherein the one or more glass-based articles have a retardance over thickness of 5 nm/mm peak-to-valley or less at all locations outside of and including 5 mm from any corner of the glass-based article and outside of and including 5 mm from any edge of the glass-based article.

In a thirty-seventh embodiment, the method of any one of the thirtieth through thirty-sixth embodiments, further including thinning the one or more glass-based articles.

In a thirty-eighth embodiment, the method of the thirty-seventh embodiment, wherein the thinning includes polishing.

In a thirty-ninth embodiment, the method of any one of the thirtieth through thirty-eighth embodiments, wherein the hold period is within a range of five minutes to eight hours, including endpoints.

In a fortieth embodiment, the method of any one of the thirtieth through thirty-ninth embodiments, wherein the glass-based sheet has a thickness within a range of 200 μm and 2 mm, including endpoints.

In a forty-first embodiment, the method of any one of the thirtieth through fortieth embodiments, wherein a heating rate at which the temperature increases is within a range of 0.1° C./minute to 100° C./minute, including endpoints.

In a forty-second embodiment, the method of any one of the thirtieth through forty-first embodiments, wherein the cooling rate is greater than or equal to 3° C./minute.

In a forty-third embodiment, the method of any one of the thirtieth through forty-second embodiments, wherein the maximum temperature is within a range of 450° C. to 1100° C., including endpoints.

In a forty-fourth embodiment, the method of the forty-third embodiment, wherein the maximum temperature is within a range of 500° C. to 700° C.

In a forty-fifth embodiment, the method of any one of the thirtieth through forty-fourth embodiments, further including strengthening the one or more glass-based articles by an ion-exchange process.

In a forty-sixth embodiment, a glass-based substrate formed by any one of the preceding embodiments.

Additional features and advantages of the disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1A depicts a method of processing a glass-based substrate to reduce birefringence according to one or more embodiments described and illustrated herein;

FIG. 1B depicts another method of processing a glass-based substrate to reduce birefringence according to one or more embodiments described and illustrated herein;

FIG. 2 depicts a digital image of a glass substrate having a birefringence defect proximate an edge;

FIGS. 3A-3D schematically depict a worst case scenario for a birefringent defect occurring in a glass-based substrate used as a cover in an electronic device;

FIG. 4 schematically depicts expected variation in light intensity versus measured retardance using a crossed polarizer system at a wavelength of 590 nm;

FIG. 5 depicts the method of processing a glass-based substrate depicted in FIG. 1A and an evolution of birefringence in the glass-based substrate according to one or more embodiments described and illustrated herein;

FIG. 6A depicts a heat treatment cycle to reduce birefringence in a glass-based article according to one or more embodiments described and illustrated herein;

FIG. 6B depicts another heat treatment cycle to reduce birefringence in a glass-based article according to one or more embodiments described and illustrated herein;

FIG. 7 schematically depicts a top view of an example glass-based substrate and an exclusion zone for measuring retardance according to one or more embodiments described and illustrated herein;

FIG. 8 graphically depicts an example retardance profile of an example glass-based substrate;

FIG. 9 depicts measurements of retardance during a glass-based substrate fabrication process according to one or more embodiments described and illustrated herein;

FIG. 10 graphically depicts the warp measured in glass samples 1.1 mm thick before and after heat treatment; and

FIG. 11 schematically depicts a sheet prior to removing quality areas and dicing into individual glass-based articles according to one or more embodiments described and illustrated herein.

### DETAILED DESCRIPTION

Referring generally to the figures, embodiments of the present disclosure are directed to glass-based substrates and methods for processing glass-based substrates to minimize the presence or appearance of birefringent defects caused by non-uniform thermal profiles. Glass-based substrates may be fabricated by a roller system wherein a roller contacts the glass-based substrates and rolls the glass-based substrates into a desired thickness. As a non-limiting example, the glass-based substrate may have an average thickness within a range of 200 μm and 2 mm at least 10 mm way from any edge. The rolling process may result in non-uniform thermal profiles in the glass-based substrate that may lead to residual stress birefringence having a linear characteristic. When the glass-based substrate is used as a cover in an electronic device that is backlit by a linearly, quasi-linearly, circularly, or quasi-circularly polarized light source, these birefringent defects in the glass-based substrate may appear as regions of lighter or darker intensity than the background. These birefringent defects may prominently appear when viewed in a crossed polarizer situation, such as when a viewer views the electronic device while wearing polarized sunglasses. As described in more detail below, the birefringent defects are more visible in a crossed polarizer situation after forming the glass-based substrate in the rolling platform while the glass-based substrate is thicker than the final product (i.e., prior to finishing steps that reduce the thickness of the glass-based substrate). This indicates that the birefringent defect approximately varies linearly with a thickness of the glass-based substrate.

As used herein, the term “glass-based substrate” includes glass materials and glass-ceramic materials. In some embodiments, the glass-based substrate does not include lithium. As a non-limiting example, the glass-based substrate is an alkali-aluminosilicate glass material. Various methods of processing glass-based substrates and the resulting glass-based substrates are described in detail below.

Most glass-based substrates have particular strain and annealing temperature points that are based on viscosity measurements of the material. Between the strain and annealing temperatures, it is possible to remove the residual stress of glass-based substrates by careful heat treatment. At the strain point the amount of time can be very long while at the annealing point it can take just a few minutes. Embodiments of the present disclosure are directed to methods of intentionally clearing the stress of the glass-based substrate to remove residual birefringent defects while still achieving the target attributes for the final product, such as after chemical strengthening after ion-exchange.

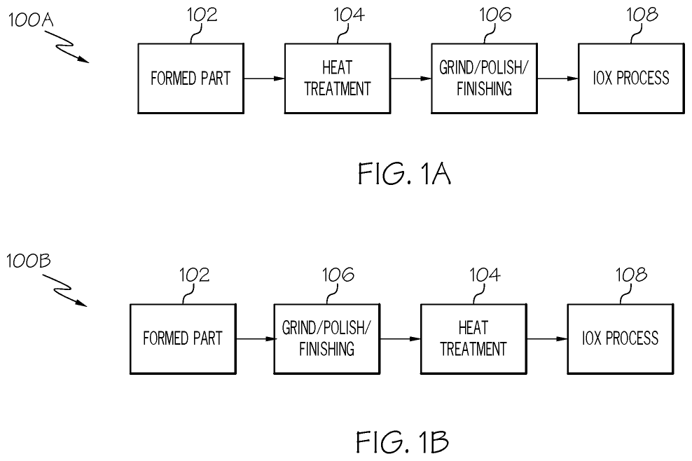

Referring now to FIG. 1A, an example method for processing a glass-based substrate to reduce birefringence is generally illustrated by flowchart 100A. At block 102, the glass-based substrate is formed into a desired thickness. The glass-based substrate may have any desired thickness depending on the application. As a non-limiting example for a cover glass for an electronic device such as a mobile telephone, the thickness may be about 0.2 mm to about 2 mm. However, the thickness of the glass-based substrates described herein is not limited by this disclosure. The glass-based substrate may be formed by any known or yet-to-be-developed rolling process. In a rolling process, molten material is passed between one or more pairs of rollers that form the material into the desired thickness. As described above and in more detail below, the forming process at block 102 may cause the formation of one or more birefringent defects in the glass-based substrate.

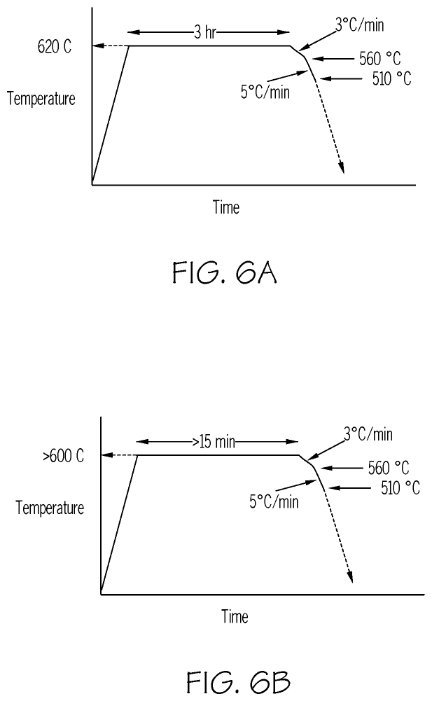

At block 104, the glass-based article is subjected to a controlled heat treatment process. The controlled heat treatment process at block 104 relaxes residual stresses in the glass-based substrate, and reduces or removes the presence of birefringent defects caused by the forming process at block 102. Example heat treatment processes are depicted in FIGS. 6A and 6B and described in detail below.

Next, the glass-based substrate is subjected to one or more finishing steps at block 106 so that the glass-based substrate is thinned to a desired thickness. The desired thickness is not limited by this disclosure. The one or more finishing steps may include grinding, polishing, etching or any other desired finishing steps to produce the end product. After finishing, the glass-based substrate may be strengthened by an ion-exchange process to achieve a desired compressive strength (CS) and depth of layer (DOL). Any known or yet-to-be-developed ion-exchange process may be utilized.

Another alternative method for reducing birefringence in glass articles is shown in the flowchart 100B of FIG. 1B. In this example method, the controlled heat treatment at block 104 is performed after the one or more finishing steps of block 106 and prior to the ion exchange process of block 108. It is noted that heat treating the glass-based substrate prior to the finishing process has an additional advantage that if the original glass-based article is thicker than the final part, any additional warp induced by the heat treatment process at block 104 may be corrected in the finishing step(s) at block 106, likely increasing the yields of the part.

As described in more detail below, the controlled heat treating of the glass-based article reduces the birefringent defects of the glass-based article.

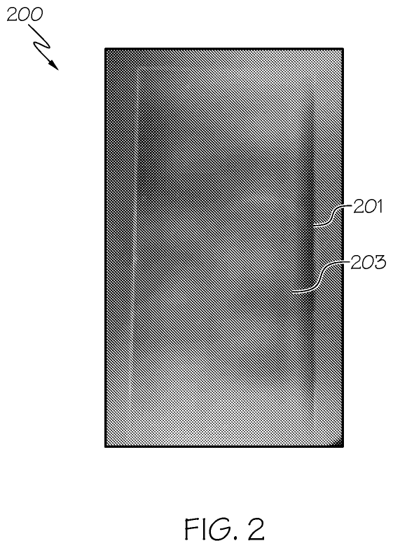

FIG. 2 depicts a digital image of a glass substrate 200 having a birefringent defect 203 proximate an edge 201. The digital image was taken using a Polarizing Stress Meter PSV-590 sold by Suzhou PTC Optical Instrument Co. Ltd. of China. The device was operated in Senarmont mode. In this mode, there is a quarter wave plate between two polarizers. The sample is placed between one of the polarizers and the quarter wave plate. The top polarizer was at 175 degrees relative to the bottom polarizer. The device uses yellow light at 590 nm. As shown in FIG. 2, the birefringent defect 203 appears as a dark region near the edge 201. This birefringent defect 203 may be distracting to a viewer, particularly a viewer wearing polarized sunglasses. For example, the birefringent defect 203 may obscure information displayed by the display of an electronic device.

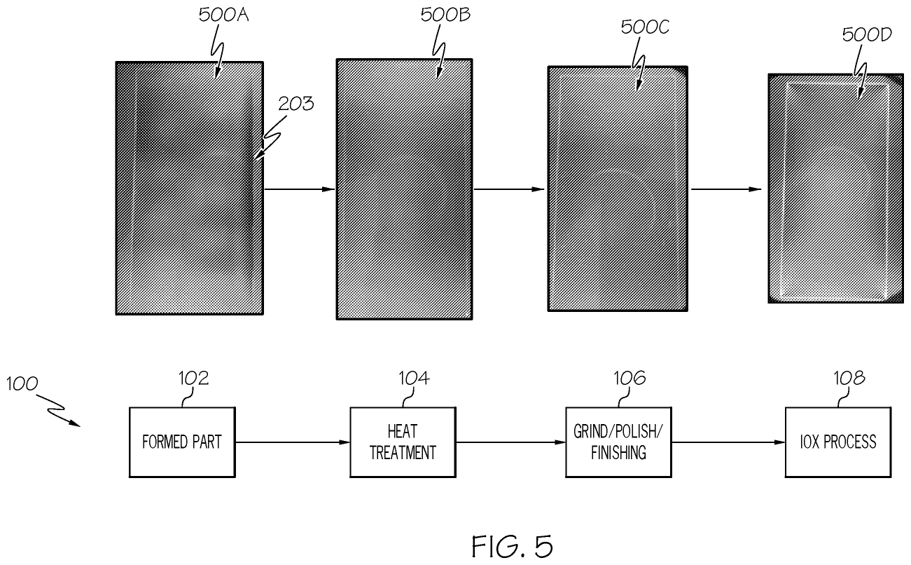

It is noted that some of the intensity variations in FIG. 2 as well as in FIG. 5 is due to reflections from the surroundings. The visible circular pattern in FIGS. 2 and 5 is from the optical set-up itself. The other is a reflection of the camera and a hand holding the camera, which is most visible in image 500C of FIG. 5. These intensity variations are not stress induced defects.

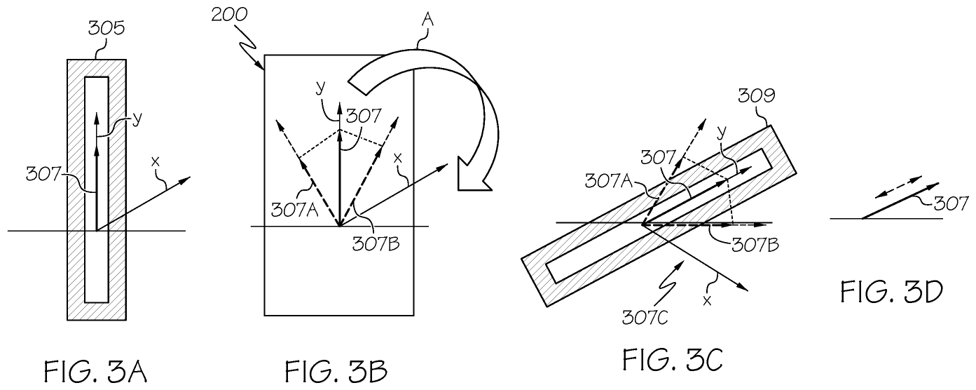

FIGS. 3A-3D schematically depict a scenario of a polarized light source via a glass-based substrate 200 by a crossed-polarizer. As shown in FIG. 3A, a liquid crystal display (LDC) 305 of an electronic device produces linearly polarized or quasi-linearly polarized light 307 along the y-axis of a coordinate system. Referring to FIG. 3B, a birefringent defect (i.e., a local change of birefringence) present within a glass-based substrate receiving the light 107 from the LCD will decompose the light into two optical waves 307A and 307B. One of these waves will be faster than the other such that each has a different velocity relative to one another. FIG. 3B shows a worst case scenario of 45 degrees of the optical axis. The overall effect for the viewer is a sense of rotation of the polarization of light when passing by the birefringent defects, as indicated by arrow A. FIG. 3C shows the rotation of the x- and y-axes due to the rotation effect of the birefringent defects. Without a presence of an output polarizer, there may be no visual perception of the birefringent defects. However, as shown in FIG. 3C, if for some reason a secondary polarizer 309 (e.g., polarized sunglasses) is used at 90 degrees (the worst case scenario) to create a crossed polarization scenario, the intensity of output light may vary depending on the retardance of the defect, as shown in FIG. 3D. Depending on the orientation of the secondary polarizer 309, the secondary polarizer may allow all, none or some percentage of light 307 to be visible to the viewer. Thus, if one uses polarizing sunglasses or an instrument providing a crossed polarizer configuration, the birefringent defect may become visible.

Retardance is an integrated effect of the birefringence defect acting along the path of a light beam that traverses the glass-based substrate. When the incident light beam is linearly polarized as described above, the two orthogonal components of the polarized light will exit the sample with a phase difference referred to as retardance. The retardance values described herein are measured in nanometers.

The formulation for the case of a birefringent plate positioned between crossed polarizers may be derived using Mueller matrices for the solution of polarization optics. The intensity of the output is given by,

$$I ≅ \frac{1}{2} {sin}^{2} ( \frac{Γ}{2} ) \qquad ( 1 )$$

Where the phase retardation Γ is given by,

$$Γ = \frac{2 π}{λ} ( {n}_{s} - {n}_{f} ) d \qquad ( 2 )$$

And can be related to the measured retardance in nm by,

$$Γ = \frac{2 π}{λ} \cdot retardance \qquad ( 3 )$$

The observer will see a light intensity variation that is dependent on the retardance of the birefringent defect present in the glass-based substrate. Referring to FIG. 2, one can see in the right side of the glass substrate 200 proximate the edge 201 a dark band indicating a higher degree of stress-birefringence in the form of a birefringent defect 203. Other wavelengths or even white light can be used to visualize the defect, having in mind that the phase retardation F is inversely proportional to the wavelength (Eq. (3)).

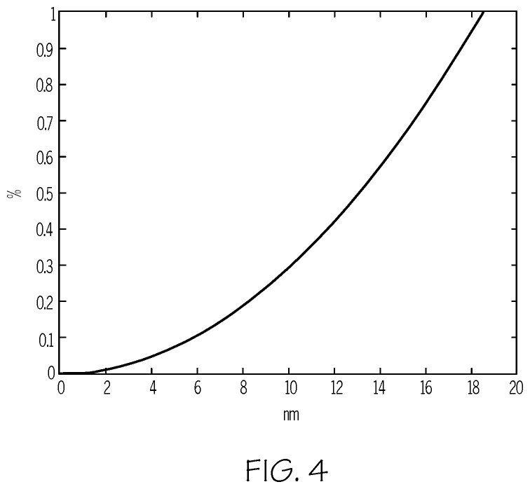

The approximated expected (assuming perfect linear polarized light) variation in light intensity compared to light prior to propagation through the glass-based substrate based on theory for a measured retardance may be computed. FIG. 4 graphically illustrates expected variation in light intensity based on theory for a measured retardance in the range of 0-20 nm using a crossed polarizer system at a wavelength of 590 nm. At 8.5 nm of retardance, the intensity variation is approximately 0.2%. The retardance effect on the intensity variation is non-linear, thereby indicating that moderate reductions in retardance can strongly impact the intensity variations. The small variation of 0.2% in intensity appearance to be sufficient for detection by a human eye if the background is relatively dark. Therefore, the heat treatment process should reduce the fluctuation in retardance (birefringence) of the glass part of the electronic device to a level where it is not easily detectable by the human eye under these conditions.

FIG. 5 illustrates the glass-substrate fabrication process illustrated by FIG. 1A along with a digital image of an example glass substrate at each process step. The digital images were taken using a crossed polarizer (PSV-590) at 590 nm wavelength. The glass substrate of the digital images of FIG. 5 was an alkali-aluminosilicate glass. The glass substrate was initially 1.1 mm thick after a rolling process at block 102. Image 500A shows the glass substrate following the rolling process. As shown in image 500A, the glass substrate has a birefringent defect 203 in the form of a dark band along the right edge. The birefringent defect extended beyond 2 mm from the right edge.

Controlled heat treating was performed at block 104. Digital image 500B shows the glass article following the controlled heat treatment step, and shows that the birefringent defect has been substantially eliminated. The controlled heat treatment step was performed in an oven according to the temperature profile depicted by FIG. 6A. The temperature was increased at a heating rate of 20° C./minute from 20° C. to a maximum temperature of 620° C. The maximum temperature was held for three hours. The temperature was then decreased at a first cooling rate of 3° C./minute from 620° C. to 560° C., a second cooling rate of 5° C./minute from 560° C. to 510° C., and a third cooling rate of the maximum cooling rate allowed by the oven. It should be understood that embodiments are not limited to the profile shown in FIG. 6A, and that other thermal profiles for the heat treatment process may be utilized. The peak hold time and the maximum temperature may be changed depending on the glass-based substrate being processed. FIG. 6B illustrates a more generic thermal profile with a maximum temperature hold period of greater than 15 minutes, and a maximum temperature of greater than 600° C.

Table 1 below illustrates the log 10 viscosities of the alkali-aluminosilicate glass substrate shown in FIG. 5 at different temperatures.

TABLE 1

| Temp (° C.) | Viscosity (Poise) |
|---|---|
| 500 | 19.84572837 |
| 510 | 19.20423554 |
| 560 | 16.47108513 |
| 600 | 14.72604867 |
| 620 | 13.96593466 |
| 700 | 11.48260442 |

It should be understood that the viscosity will be different for other glass-based substrates and that embodiments are not limited to the viscosities and temperatures of Table 1.

It is noted that complete stress relief is not necessary. Partial stress relief at less severe thermal profiles (e.g., 580° C. for 15 minutes or 550° C. for one hour) may be enough to remove the intensity bands caused by birefringent defects in the display area of the cover of the electronic device when seen through nearly-crossed polarizer situations. As further non-limiting examples, the heating rate at which the temperature is increased may be within a range of 0.1° C./minute to 100° C./minute, including endpoints, the cooling rate at which the temperature decreases may be within a range of 0.1° C./minute to 100° C./minute, including endpoints, and the hold period may be within a range of 1 minute to 8 hours, including endpoints. As another non-limiting example, the hold period may be within a range of 5 minutes to 8 hours, including endpoints.

Referring once again to FIG. 5, at block 106, additional finishing steps were performed, resulting in a final thickness of the glass substrate of 0.8 mm. Digital image 500C illustrates that the birefringent defect shown in digital image 500A remains substantially eliminated. As stated above, performing the heat treatment step at a larger thickness before the grinding/polishing/finishing step(s) may be advantageous as to any warp in the glass-based substrate that may occur due to the heat treatment step. The grinding/polishing/finishing step(s) can thus correct any warp that may be present. Finally, at block 108, an ion-exchange process is performed. In the illustrated example, the ion-exchange process was 430 C for 4.5 hours in a bath of 93.5 wt % KNO₃/6.5 wt % NaNO₃. After the ion-exchange process, digital image 500D shows that the birefringent defect remains substantially eliminated.

Peak-to-valley retardance is the maximum retardance over thickness subtracted by the minimum retardance over thickness over a length of glass-based substrate from one edge of the glass-based substrate to an opposite edge of the glass-based substrate. When performing the retardance peak-to-valley calculation along a line, the direction of the measurement is orthogonal to a first edge and a second edge.

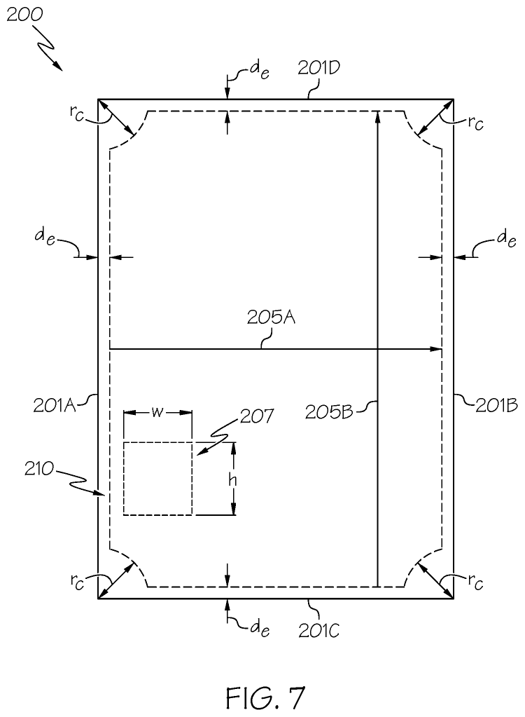

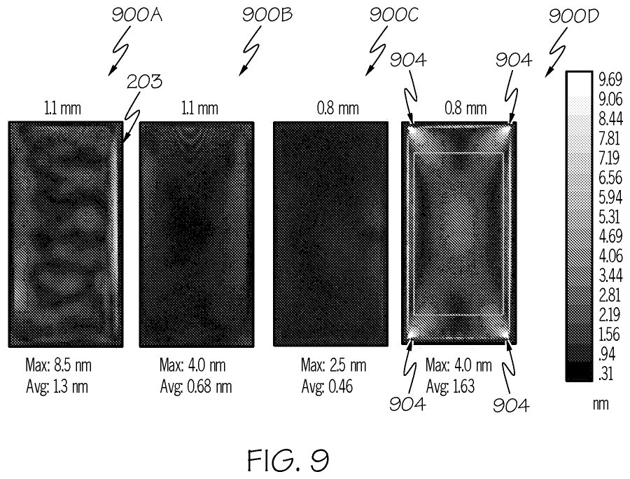

FIG. 7 schematically illustrates a top view of an example glass-based substrate 200 and a method for measuring retardance over thickness in peak-to-valley terms. The glass-based substrate 200 has a first edge 201A, a second edge 201B opposite from the first edge 201A, a third edge 201C, and a fourth edge 201D opposite the third edge 201C. There may always be a high retardance values very close to the edges of the glass-based substrate 200. However, these birefringence defects do not typically distract the viewer of electronic devices. Further, there may be high retardance values proximate the corners of the glass-based substrate 200 due to the ion-exchange process as described below and shown in FIG. 9. Thus, measurements of retardance over thickness herein are made outside of an exclusion zone 210 proximate the edges and corners of the glass-based substrate 200.

As shown in FIG. 7, the exclusion zone 210 extends an edge distance dₑ from the first edge 201A, the second edge 201B, the third edge 201C, and the fourth edge 201D, as well as a corner radius r_{c} from any corner of the glass-based substrate 200. In some embodiments, the corner radius r_{c} of the exclusion zone is larger than the edge distance dₑ. In other embodiments, the corner radius r_{c} of the exclusion zone is equal to or smaller than the edge distance rₑ. As a non-limiting example, the corner radius r_{c} and the edge distance dₑ are within a range of 1 mm to 5 mm, including endpoints. As another non-limiting example, the corner radius r_{c} and the edge distance dₑ are each 5 mm. In another non-limiting example, the corner radius r_{c} and the edge distance dₑ are 2 mm and 1 mm, respectively. The corner radius r_{c} and the edge distance dₑ are chosen to exclude from measurement regions of the glass-based substrate that do not affect viewing of the display of the electronic device.

Still referring to FIG. 7, retardance over thickness of the glass-based substrate is measured from one edge of the glass-based substrate 200 to an opposite edge of the glass-based substrate 200 outside of the exclusion zone 210. In other words, the retardance over thickness measurements are taken at locations outside of and including the edge distance dₑ and the corner radius r_{c} value from the edge and corner, respectively. Additionally, measurements are taken in a direction that is orthogonal from a start edge to a terminating edge. Measurement direction 205A is taken from the first edge 201A (i.e., a start edge) toward the second edge 201B (i.e., a terminating edge) at locations outside of and including the edge distance dₑ value. Measurement direction 205B is taken from the second edge 201 (i.e., a start edge) toward the fourth edge 201D (i.e., a terminating edge) at locations outside of and including the edge distance dₑ value.

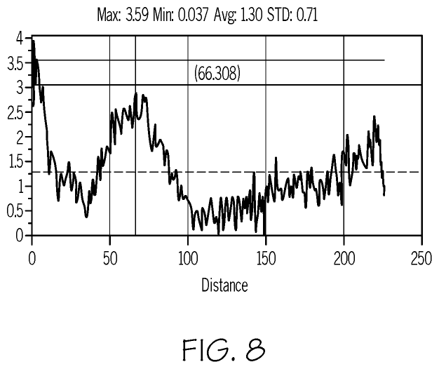

In embodiments described herein, all locations outside of the exclusion zone meet the minimum retardance over thickness minimum of 5 nm/mm peak-to-valley measured as described above. FIG. 8 graphically illustrates an example retardance profile over a distance from one edge of a glass-based substrate to the opposite edge. The peak-to-valley is the maximum retardance minus the minimum retardance. In the illustrated example, the maximum retardance is 3.08 nm/mm at 66 pixels from the edge and the minimum is 0.037 nm/mm, providing a peak-to-valley retardance of 3.043 nm/mm.

Further, in some embodiments, the peak-to-valley retardance is below a predetermined threshold value within any area having predetermined dimensions that is outside of the exclusion zone 210. As shown in FIG. 7, an area 207 has a width and a height. The peak-to-valley retardance is below the predetermined threshold within the area 207. In any area drawn having the width and height, the peak-to-valley retardance over thickness is below the predetermined threshold. In one example, the peak-to-valley retardance over thickness is below the predetermined threshold (e.g., 5 nm/mm) in any 25 mm by 25 mm area outside of the exclusion zone 210.

Referring now to FIG. 9, posterior retardance measurements of the sample at each step of the process illustrated by FIG. 5 are illustrated by digital images 900A-900D. The retardance was measured using a StressPhotonics GFP-1400 strainscope at each step to reveal the magnitude of the birefringent defect. The concern is any birefringent defect at locations outside of and including 2 mm from any corner of the glass-based substrate and outside of and including 1 mm from any edge of the glass-based substrate (i.e., outside of a predetermined exclusion zone). Digital image 900A clearly shows the presence of a birefringent defect 203 at the left edge having a maximum birefringence (retardance) over thickness of 8.5 nm/mm and an average of 1.3 nm/mm. There is a clear reduction in the birefringent defect after the heat treatment step as shown in digital image 900B (maximum retardance over thickness of 4 nm/mm and an average of 0.68 nm/mm). Digital image 900C shows retardance after the polishing/grinding/finishing steps (maximum retardance over thickness of 2.5 nm/mm and average of 0.46). Digital image 900D shows retardance after the ion-exchange process (maximum retardance over thickness of 4 nm/mm and an average of 1.63 nm/mm). It is noted that in square or rectangular parts with sharp edges there is an induction of retardance/birefringence at the corners of the part due to the ion-exchange process as shown in digital image 900D (corner birefringent defects 904). This inducement of birefringence is typical of ion-exchange processes due to the asymmetry of the geometry at the corners. FIG. 9 shows that the birefringent defect 203 is reduced from a range of 8.5 nm/mm to around 3 nm/mm in retardance in peak-to-valley terms (p-v). Changes in retardance over thickness of less than 5 nm/mm (regardless of the average level of retardance of the glass-based substrate) would be more difficult for the human eye to detect and perhaps not displeasing under visualization via a crossed polarizer.

The controlled heat treatment step may affect the ion-exchange strengthening step. Table 2 shows measurement results using the FSM-6000LE for CS (compressive surface stress) and DOL (depth of layer that is related to the diffusion length) of a non-heat treated glass sample and a heat treated glass sample, respectively.

The heat treatment used was the mentioned 3 hours at 620° C. cycle demonstrated. The IOX cycle here is as mentioned 430° C. for 4.5 hours in a bath of 93.5 wt % KNO₃/6.5 wt % NaNO₃. The compressive stress of the non-heat treated glass sample was 648 MPa and the compressive stress of the heat treated glass sample was 702 MPa. The DOL of the non-heat treated glass sample was 8 μm and the DOL of the heat treated glass sample was 7.2 μm.

TABLE 2

| Parameter | Non-heat treated | Heat treated |
|---|---|---|
| CS | 648 | 702 |
| DOL (μm) | 8 | 7.2 |

Table 2 shows that the heat treated sample has a smaller DOL than the non-heat treated glass sample indicating a smaller ion diffusivity for the heat treated sample. The ion diffusivity of the glass is then affected by the overall thermal history of the glass sample. Samples that were heat treated diffused slower than samples that were not heat treated. For this reason, the IOX time may be corrected and elongated by approximately 23% in order to compensate for the change in IOX diffusivity due to the added heat treatment cycle. It is expected that the amount of correction will depend on the temperature and time used in the heat treatment cycle as well as the glass composition.

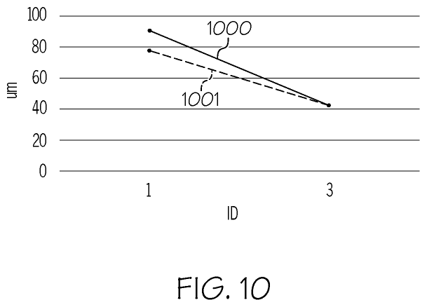

FIG. 10 graphically depicts the warp measured in glass samples 1.1 mm thick before and after heat treatment. Curve 1001 corresponds with the glass sample as-formed prior to heat treatment. Curve 1000 corresponds with the glass-sample after heat treatment. The warp was measured with an OGP Laser coordinate measurement machine (OGP SmartScope Quest 300) with the glass samples placed on a 3-point support. The measurements were made with 1 mm spacing along the width and 5 mm spacing along the length of the glass samples. From the raw measurements, the best-fit plane was subtracted and the warp (i.e., the maximum surface height minus the minimum surface height) was calculated.

After heat treatment, the overall warp was still below 100 μm for tests with two different glass samples. The samples exhibited a warp/diagonal of 0.007 μm/mm² or less after the heat treatment process. The heat treatment cycle was 15 minutes at 620° C. (maximum temperature) as illustrated by FIG. 6B. It is noted that the actual annealing point of this glass was approximately 22° C. higher than the temperature of the heat treatment furnace (about 642 C). At the maximum heat treatment temperature, thin (<5 mm) glass pieces can warp appreciably, particularly when loaded in vertical orientations. Heat treating the glass-based substrates flat on setters can potentially reduce warp, but the setter flatness has to be controlled very tightly. Thus, the temperature for stress relief was deliberately chosen to be below the annealing point to reduce warp when parts are loaded vertically.

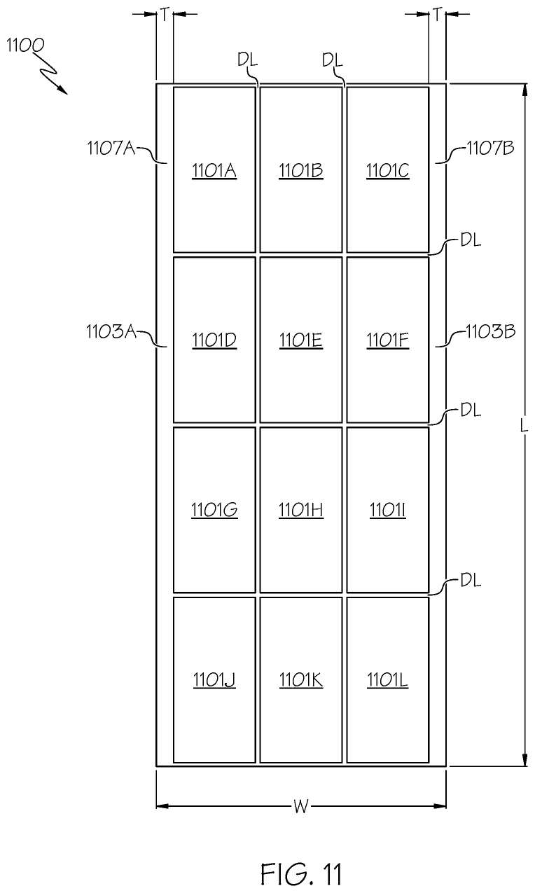

In some embodiments, glass-based substrates may be heat-treated at a sheet level rather than at an article level. FIG. 11 schematically illustrates a top view of a glass-based sheet 1100 having a width W and a length L. The sheet is formed by rolling a glass-based material in a direction parallel to the length L of the glass-based sheet 1100 shown in FIG. 11. The sheet 1100 will be later divided into a plurality of glass-based articles 1101A-1101L along dicing lines DL.

Stress within the sheet 1100 may be present both proximate the edges as well as in the interior of the sheet 1100 due to the rolling process as described above, or for other reasons. This stress may cause birefringence defects as described above. Therefore, stress within the interior of the sheet that would be present in any of the glass-based articles 1101A-1101L after separation should be removed or otherwise reduced.

The sheet 1100 may be heat-treated by the heat treatment processes described above. Particularly, the sheet 1100 is heated to a maximum temperature for a hold period such that stresses within the sheet 1100 are relaxed. The sheet 1100 is then cooled from the maximum temperature and separated by any known or yet-to-be developed separation method (e.g., scribing and breaking the sheet 1100 along dicing lines DL).

As shown in FIG. 11, a first quality area 1107A is proximate a first edge 1103A of the sheet 1100 and a second quality area 1107B is proximate a second edge 1103B of the sheet 1100. The first and second quality areas 1107A, 1107B are areas of the sheet 1100 that are trimmed off of the sheet 1100 to remove imperfections that may have resulted during the sheet fabrication process. For example, the handling of the sheet 1100 may be performed in the first and second quality areas 1107A, 1107B, and such handling may create undesirable imperfections. Defects may also be due to edge effects. The first and second quality areas 1107A, 1107B may be trimmed off mechanically by a blade or by a laser process, for example.

The first and second quality areas 1107A, 1107B have a thickness T. Thus, when the sheet 1100 is trimmed, it has a total width of W−2T. As a non-limiting example, the initial width W of the sheet 1100 is 250 mm and the thickness of the first and second quality areas 1107A, 1107B is 10 mm each, thereby leaving a trimmed width of 230 mm after the trimming process. As another non-limiting example, the initial width W of the sheet 1100 is 280 mm and the thickness T of the first and second quality areas 1107A, 1107B is 25 mm, thereby leaving a trimmed width of 230 mm after the trimming process. It should be understood that the thickness of the first and second quality areas 1107A, 1107B may not be equal in some embodiments.

The individual glass-based articles 1101A-1101L are divided from the sheet 1100 along dicing lines DL by any known or yet-to-be-developed method. Non-limiting dicing methods include mechanical separation by use of a blade or by a laser process. Because the compresses stresses due to the fabrication process of the sheet 1100 are minimized by the heat treatment process, the variation in retardance within the interior of the sheet 1100 (and thus within the separated glass-based articles 1101A-1101L) is minimized. The glass-based articles 1101A-1101L have a retardance over thickness of 5 nm/mm peak-to-valley or less at all locations outside of and including 5 mm from any corner of the glass-based substrate and outside of and including 5 mm from any edge of the glass-based substrate, as described above. Some stresses and therefore variations in retardance may be present proximate the edges of the glass-based articles 1101A-1101L due to the method of separating the glass-based articles 1101A-1101L. However, this stress and variations in retardance will be within 5 mm from any edge or corner of the glass-based articles 1101A-1101L.

The presence of the first and second quality areas 1107A, 1107B enable the sheet to be cooled at a faster cooling rate than the when glass-based articles are heat-treated individually. For example, whereas the cooling regimes of FIGS. 6A and 6B include multiple cooling rates, when heat treating the sheet 1100, the cooling rate may be the maximum allowed by the heat treatment oven, or the sheet 1100 may be removed from the oven to be cooled in ambient temperature. As a non-limiting example, the cooling rate may be greater than or equal to 3° C./minute.

Cooling the sheet 1100 quickly without tapered cooling rates may cause compressive stress to form proximate the first and second edges 1103A, 1103B of the sheet 1100. This compressive stress due to the cooling may create birefringence defects as discussed above. However, because this compressive stress due to the cooling is proximate the first and second edges 1103A, 1103B and within the first and second quality areas 1107A, 1107B, any defects caused by the compressive stress will be mitigated following the trimming of the first and second quality areas 1107A, 1107B. Therefore, internal stresses due to rolling of the sheet 1100 (i.e., stresses within the glass-based articles 1101A-1101L) are minimized by the heat treatment process as described above, and any potential birefringence defects due to compressive stresses caused by rapid cooling within the first and second quality areas 1107A, 1107B are mitigated by the trimming process. Thus, processing the entire sheet prior to separating the sheet into a plurality of glass-based articles may increase heat treatment throughput because a faster cooling rate may be utilized.

It should now be understood that embodiments of the present disclosure provide processes that can correct birefringence defects that occur in forming of the glass-based substrates and still be compatible with downstream processes used for the manufacturing of cover glass-based sheets.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1-46. (canceled)

47. A method for processing a glass-based substrate, the method comprising:
rolling a glass-based material to form the glass-based substrate; and
heat treating the glass-based substrate by increasing a temperature of the glass-based substrate, holding the temperature at a maximum temperature for a hold period, and then decreasing the temperature at one or more cooling rates, wherein after the heat treating, the glass-based substrate has a retardance over thickness of 5 nm/mm peak-to-valley or less at all locations outside of and including 5 mm from any corner of the glass-based substrate and outside of and including 5 mm from any edge of the glass-based substrate.

48. The method of claim 47, wherein prior to the heat treating, the glass-based substrate has a birefringence defect located 1 mm or more from an edge, and the retardance over thickness of the birefringence defect is greater than 5 nm/mm peak-to-valley.

49. The method of claim 48, wherein the retardance over thickness of the birefringence defect is 8 nm/mm peak-to-valley or more.

50. The method of claim 47, further comprising ion-exchanging the glass-based substrate, wherein the hold period is within a range of five minutes to eight hours, including endpoints.

51. The method of claim 47, wherein, after the heat treating, the glass-based substrate has a visual detection of light intensity using a crossed polarizer that varies less than 0.2% compared to a light intensity of light prior to transmission through the glass-based substrate.

52. The method of claim 47, wherein:
a heating rate at which the temperature increases is within a range of 0.1° C./minute to 100° C./minute, including endpoints; and
the one or more cooling rates is within a range of 0.1° C./minute to 100° C./minute, including endpoints.

53. The method of claim 47, wherein:
the one or more cooling rates comprises a first cooling rate, a second cooling rate, and a third cooling rate; and
the first cooling rate is 3° C./minute from 620° C. to 560° C., the second cooling rate is 5° C./minute from 560° C. to 510° C., and the third cooling rate is a maximum cooling rate allowed by an oven used for the heat treating.

54. The method of claim 47, wherein the maximum temperature is within a range of 450° C. to 1100° C., including endpoints.

55. The method of claim 54, wherein the maximum temperature is within a range of 500° C. to 700° C.

56. The method of claim 47, wherein the glass-based substrate has a warp/diagonal² of 0.007 μm/mm² or less after the heat treating.

57. The method of claim 47, further comprising strengthening the glass-based substrate by an ion-exchange process after the heat treating.

58. The method of claim 47, wherein the retardance over thickness of the glass-based substrate is m/mm peak-to-valley or less at locations outside of and including 2 mm from any corner of the glass-based substrate and outside of and including 1 mm from any edge of the glass-based substrate.

59. The method of claim 47, wherein the retardance over thickness of the glass-based substrate is 3 nm/mm peak-to-valley or less within any 25 mm by 25 mm area located outside of an including 2 mm from any corner of the glass-based substrate and outside of and including 1 mm from any edge of the glass-based substrate.

60. A method of fabricating one or glass-based articles, the method comprising:
rolling a glass-based material to form a glass-based sheet;
heat treating the glass-based sheet by increasing a temperature of the glass-based sheet, holding the temperature at a maximum temperature for a hold period, and then decreasing the temperature at a cooling rate, wherein after the heat treating, the glass-based sheet has a retardance over thickness of 5 nm/mm peak-to-valley or less at all locations outside of and including 10 mm from any edge of the glass-based sheet;
removing a first quality area of the glass-based sheet, wherein the first quality area extends at least 10 mm from a first edge of the glass-based sheet and along a length of the glass-based sheet, and the length of the glass-based sheet is a direction of the rolling of the glass-based material;
removing a second quality area of the glass-based sheet, wherein the second quality area extends at least 10 mm from a second edge of the glass-based sheet and along the length of the glass-based sheet; and
separating the one or more glass-based articles from the glass-based sheet.

61. The method of claim 60, wherein, after heat treating the glass-based sheet, the glass-based sheet has a retardance over thickness of 5 nm/mm peak-to-valley or more within at least one of the first quality area and the second quality area.

62. The method of claim 60, wherein the glass-based material is glass.

63. The method of claim 60, wherein the glass-based material is a glass-ceramic.

64. The method of claim 60, wherein the one or more glass-based articles have a retardance over thickness of 5 nm/mm peak-to-valley or less at all locations outside of and including 5 mm from any corner of the glass-based article and outside of and including 5 mm from any edge of the glass-based article.

65. The method of claim 60, wherein:
a heating rate at which the temperature increases is within a range of 0.1° C./minute to 100° C./minute, including endpoints; and
the cooling rate is greater than or equal to 3° C./minute.

66. The method of claim 60, wherein the maximum temperature is within a range of 450° C. to 1100° C., including endpoints.
